(19) United States
(12) Patent Application Publication
(10) Pub. No.: US 2022/0212464 A1
(43) Pub. Date: Jul. 7, 2022

(54) PROCESSING STATION HAVING A FIRST AND A SECOND CYLINDER FOR PROCESSING A SUBSTRATE WEB

(71) Applicant: MPS Holding B.V., Arnhem (NL)

(72) Inventor: Lambert Dirk VAN DEN BRINK, Südlohn (DE)

(73) Assignee: MPS Holding B.V., Arnhem (NL)

(21) Appl. No.: 17/606,833

(22) PCT Filed: May 1, 2020
(86) PCT No.: PCT/NL2020/050277

§ 371 Date: Oct. 27, 2021

(30) Foreign Application Priority Data
May 1, 2019 (NL) 2023046

(51) Int. Cl. B41F 27/02; B65H 23/04; B26F 1/38; B44B 5/00; B41F 19/02

(52) U.S. Cl. CPC B41F 27/02; B65H 23/048; B65H 2513/10; B44B 5/0009; B41F 19/02; B26F 1/384

(57) ABSTRACT

A processing station for processing a substrate web supplied and led away with a substantially continuous speed includes an impression roller and two tool cylinders. Within one revolution of the tool cylinder, the transport speed of the substrate web at a contact area between tool cylinder and impression roller can periodically vary relative to the rotation speed of the tool cylinder. Of the two tool cylinders, at any time only one is in an operative state in that it is in engagement with an impression roller. The other tool cylinder is in a non-operative state in which it can be made accessible for thereon exchanging a tool plate.

### FIELD

The invention relates to a processing station for processing a substrate web which is supplied to the processing station and led away from the processing station with a substantially continuous speed.

### BACKGROUND

Such a processing station is for instance described in US 2005/0098052 which is considered the closest state of the art. The known processing station for processing a substrate web which is supplied and led away with a substantially continuous speed comprises an impression roller and a rotatably mounted tool cylinder onto which a first tool plate is securable. In use, the tool cylinder, at a contact area, with insertion of the substrate web, engages the impression roller for carrying out a processing operation on the substrate web. Within one revolution of the tool cylinder, a transport speed of the substrate web at the contact area can periodically vary relative to the rotation speed of the tool cylinder. Thus, on the tool cylinder, a tool plate can be secured whose wrap length around the tool cylinder is considerably smaller than π (pi) times the diameter of the tool cylinder. Consequently, a tool plate is then present only over a part of the circumference of the tool cylinder and the remainder of the circumference of the tool cylinder is not provided with an operative tool plate. On the tool cylinder a continuous rotation speed can then be imposed and the substrate web, during the moment that the tool plate is not in engagement with it, can be temporarily stopped or even be reversed to some extent in the processing station, so that after the substrate web is speeded up again, the next contact of the substrate web with the tool plate directly or practically directly adjoins the pattern applied to the substrate web in a preceding revolution of the tool cylinder. Thus, on the substrate web, patterns can be applied with the tool plate having a smaller wrap length than the tool cylinder and where these patterns on the substrate web still adjoin each other directly or practically directly. The reason, in fact, being that the substrate web, during the passage of the portion of the tool cylinder that is not covered with a tool plate, temporarily stands still, or even momentarily reverses, then to be accelerated again to the same speed as the circumferential speed of the tool cylinder with tool plate. In the known apparatus, the tool plate can be a die plate or a printing plate.

This processing station provides the advantage over the processing stations known up until then, that the relatively heavy tool cylinder does not need to be exchanged every time a pattern of a different length is to be provided on a substrate web. As the tool cylinders are heavy, exchanging them is time consuming because often a crane has to be deployed. With the processing station known from US 2005/0098052A1, it can suffice to exchange the light, wieldable tool plates even when the wrap length thereof is considerably shorter than the circumference of the tool cylinder.

### SUMMARY

During exchange of a tool plate on the tool cylinder, it is not possible with the known processing station to keep production going at the same time. As these processing stations are often part of sizeable apparatuses consisting of a large number of in-line series arranged printing stations and other processing stations, standstill entails a substantial loss because at standstill a machine line costing about one or two million euros is inoperative. Especially with a die or with an embossing processing operation, exchange of the tool plate is regularly necessary because the die tools become blunt rather fast and embossing plates also wear relatively fast. Moreover, the plates are not only exchanged as a consequence of wear but also as a consequence of a design switch which requires different plates.

The invention contemplates a solution to these issues. In other words, the invention contemplates a processing station which a substrate web is supplied to and led away from with a constant speed and wherein the substrate web within one revolution of the tool cylinder travels with periodically varying speed and which allows the tool plate to be exchanged without production loss.

To this end, the invention provides an apparatus according to claim 1. More particularly, the invention provides a processing station for processing a substrate web supplied and led away with a substantially continuous speed, comprising:
an impression roller; and
a rotatably mounted tool cylinder on which a first tool plate is securable and which, in use, at a contact area, with insertion of the substrate web, engages the impression roller for carrying out a processing operation on the substrate web;
a mechanism configured, within one revolution of the tool cylinder, to periodically vary a transport speed of the substrate web at the contact area relative to the rotation speed of the tool cylinder;

characterized in that the processing station comprises a first and a second rotatably mounted tool cylinder which can each be provided with a tool plate, wherein of the two tool cylinders, at any time only one is in an operative state while the other is in a non-operative state, wherein the operative state is provided in that an impression roller, with insertion of the substrate web, at a contact area is in engagement with the tool cylinder in the operative state, wherein the non-operative state is provided in that the non-operative tool cylinder is not in engagement with the substrate web and an impression roller, wherein the non-operative tool cylinder of the two tool cylinders is available and accessible for thereon exchanging a tool plate.

The processing station according to the invention is practically continuously employable because placing a tool plate can be done while the operation on the substrate web is in progress, since the first tool cylinder can be operative while on the second tool cylinder the tool plate is being exchanged and vice versa. As, moreover, the processing station comprises a mechanism which is configured, within one revolution of the tool cylinder, to periodically vary the transport speed of the substrate web at the contact area relative to the rotation speed of the tool cylinder, it is possible to work with tool plates whose wrap length is smaller than the circumference of the tool cylinder. Exchanging heavy tool cylinders, which, as has already been described in the background section, is time consuming and not without risk either, is therefore not, or hardly, necessary anymore. With the processing station according to the invention, therefore, a practically continuously employable processing station is provided, with which practically uninterruptedly die-cutting work, embossing work, printing work and the like can be carried out.

It is noted that the first and the second tool cylinder do not necessarily need to have a same diameter. Moreover, the tool cylinders may be of the so-called sleeve type, whereby sleeves of different diameters can be slid onto a mandrel. On such a sleeve, in turn, a tool plate can be arranged. A number of embodiments are described in the subclaims and will hereinafter, with reference to two examples represented in the drawings, be further clarified.

### BRIEF DESCRIPTION OF THE DRAWINGS

FIG. 1 is a perspective view of a first example of a processing station according to the invention;

FIG. 2 is a top plan view of the example represented in FIG. 1;

FIG. 3 is a front view of the example of FIG. 1;

FIG. 4 is a cross-sectional view along line IV-IV in FIG. 2;

FIG. 5 is a perspective view of a second example of a processing station according to the invention;

FIG. 6 is a top plan view of the example represented in FIG. 5; and

FIG. 7 is a cross-sectional view along line VII-VII in FIG. 6.

### DETAILED DESCRIPTION

In the following description, the reference numerals serve only for clarification but have no limiting effect. The embodiments described may also be implemented in a different manner than is represented in the example shown in the figures. The embodiments can be applied independently of each other or in combination with each other.

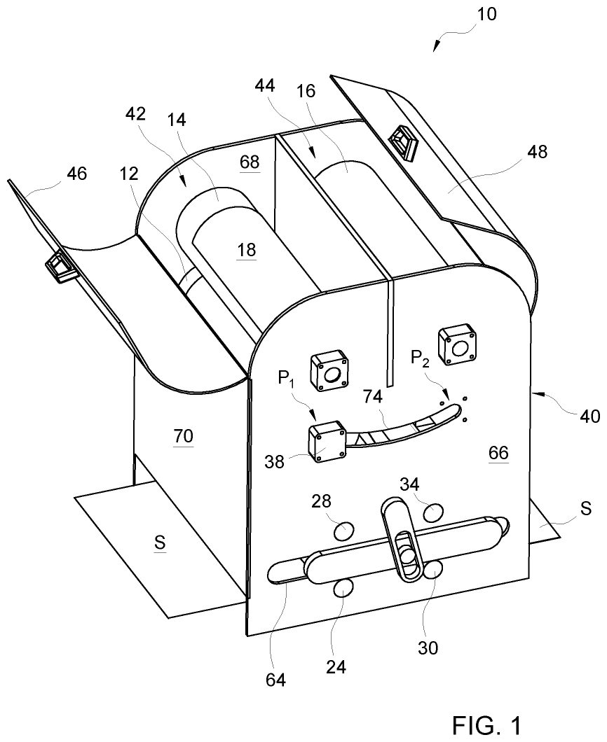

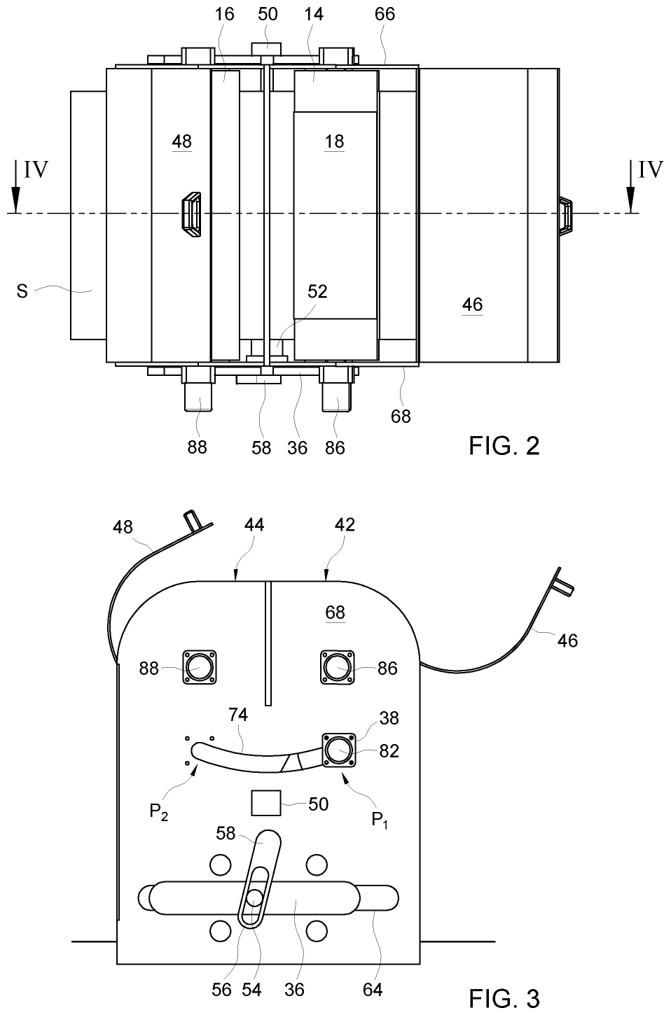

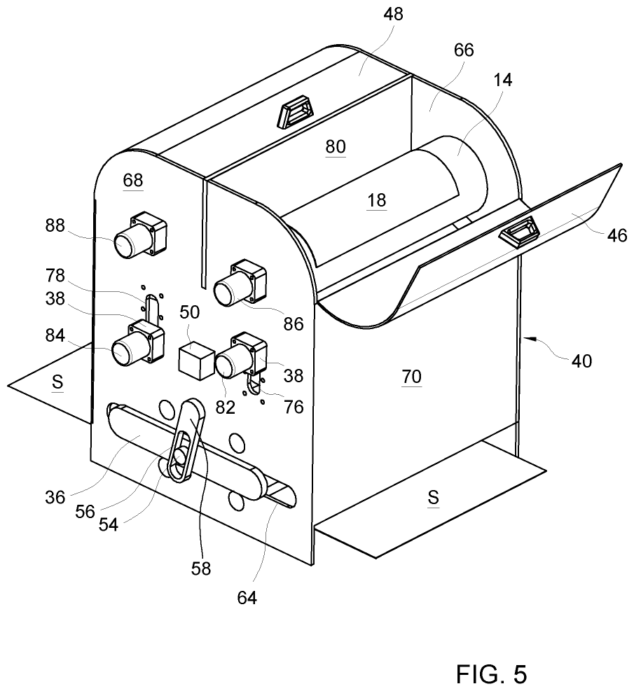

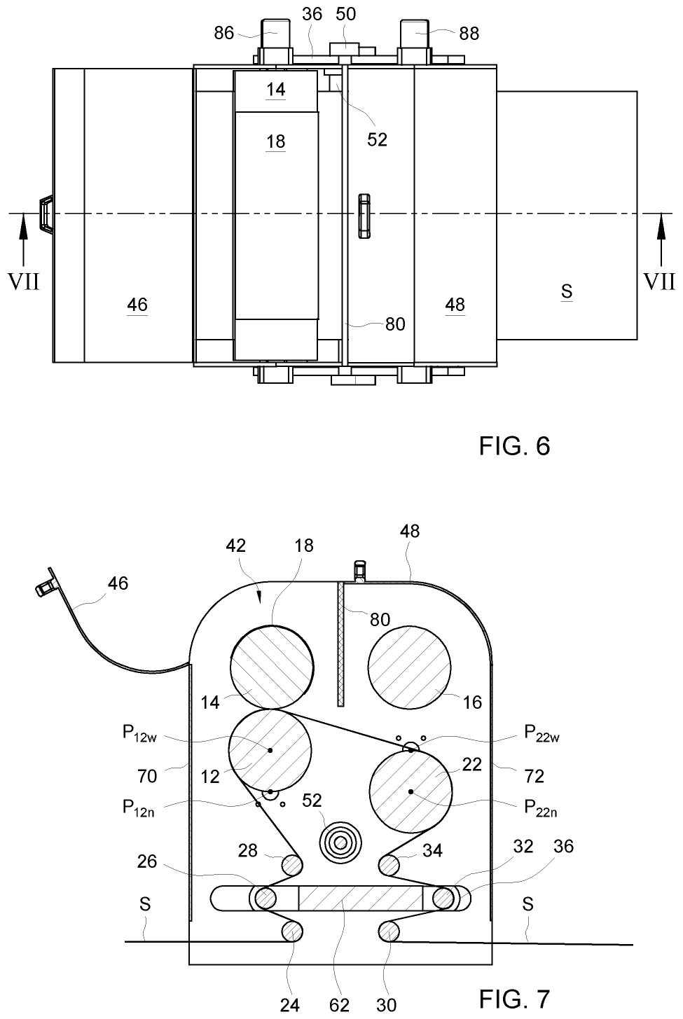

Most generally, the invention provides a processing station 10 for processing a substrate web S supplied and led away with a substantially continuous speed. The processing station 10 is provided with a single impression roller 12 of which an example is shown in FIGS. 1-4 or two impression rollers 12, 22 of which an example is shown in FIGS. 5-7. The processing station 10 is further provided with a first 14 and a second 16 rotatably mounted tool cylinder which can each be provided with a tool plate 18. In addition, the processing station 10 is provided with a mechanism which is configured, within one revolution of the tool cylinder 14, 16 to periodically vary the transport speed of the substrate web S at the contact area relative to the rotation speed of the tool cylinder 14, 16. Of the two tool cylinders 14, 16, at any time only one is in an operative state while the other is in a non-operative state. The operative state is provided in that an impression roller 12; 12, 22, with insertion of the substrate web S, at a contact area is in engagement with the tool cylinder 14, 16 in the operative state. The non-operative state is provided in that the non-operative tool cylinder 14, 16 is not in engagement with the substrate web S and an impression roller 12 or, if present, 22. The non-operative tool cylinder 14, 16 of the two tool cylinders 14, 16 is available and accessible for thereon exchanging a tool plate 18.

Such a processing station 10 has the advantages which have already been discussed hereinbefore under the heading “SUMMARY” and which are to be considered inserted here. In the example represented, the tool cylinders 14, 16 have the same diameter. As already noted earlier, the first and the second tool cylinder 14, 16 may also have a diameter deviating from each other. It is possible to exchange the whole tool cylinder 14 and/or 16. It is also possible, however, that the tool cylinders 14, 16 are of the so-called sleeve type, where a cylindrical sleeve has been slid over a mandrel. In that case, when a diameter is to be changed, only another sleeve needs to be slipped on the mandrel. On this other sleeve, in turn, the new tool can then be arranged, for example by sticking on a flexible tool plate.

In the examples shown, the mechanism for varying the speed of the substrate web S within the processing station is formed by a reciprocably movable slide which carries two guide rollers, which will be reverted to hereinafter. The invention is not limited to such a mechanism. The mechanism may also be formed by guide rollers controllable with a servo motor and one or more dancer rollers to keep the substrate web S under tension. It is important that the supply and leading away of the substrate web S to and from the processing station 10 can take place continuously, and in practice with a substantially constant speed. In the example shown, the tool cylinders 14, 16 and the impression rollers 12 and, if present, 22 are bearing-mounted in two frame plates 66, 68 extending parallel to each other. The frame plates 66, 68 may be mutually connected with each other by a number of bars, not shown in the figures. Also, it is possible that the frame plates 66, 68 are connected with each other by two end walls 70, 72. In the examples shown, the end walls 70, 72, at the underside thereof, leave an opening clear through which the substrate web S can be introduced into and led away from the processing station 10. In practice, the tool cylinders 14, 16 are driven by motors 86, 88. Typically, these motors 86, 88 will be implemented as servo motors, so that the tool plate 18, with which, for example, blanking, embossing or print patterns are applied, can automatedly be brought into register with patterns applied previously, or to be applied later, on the substrate web S.

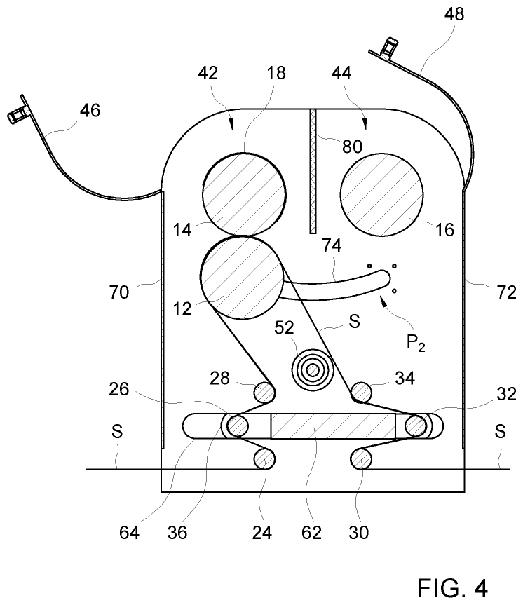

In an embodiment, of which two examples are shown in the figures, the processing station 10 may comprise, for the purpose of the variation of the transport speed of the substrate web S at the location of a contact area as mentioned, a first and a second set of three idler rollers 24, 26, 28 and 30, 32, 34. The substrate web S is then, in use, guided zigzag over each set of three idler rollers, as is clearly visible in the cross-sectional views of the example shown in FIGS. 4 and 7. Each set of three rollers comprises, viewed in the transport direction of the substrate web, an upstream 24, 30, an intermediate 26, 32, and a downstream roller 28, 34. The upstream roller 24, 30 and the downstream roller 28, 34 have a rotation axis with a fixed position. The intermediate roller 26, 32 of both the first and the second set of three rollers is connected with a roller frame 36 which is mounted movably in a reciprocating manner.

In the two examples shown, the roller frame 36 is provided with a pin 54 which engages in a slot 56 of a pivoting arm 58. The pivoting arm 58 is rotated back and forth by an electric motor 52. As a result, the roller frame 36, which is provided with a guide block 62 included in a guide slot 64, reciprocates. Thus, a robust mechanism is provided to vary the speed of the substrate web S in the processing station 10. When the main transport direction of the substrate web S is from left to right in FIGS. 4 and 7, the local speed of the substrate web S at the contact area between the tool cylinder 14 and the impression roller 12 will be lower than the supply speed when the roller frame 36 moves to the left and higher than the supply speed when the roller frame 36 moves to the right. The lower speed in the contact area can even be reduced to zero in this way.

It will be clear that also other forms of drive are among the possibilities. For example, use can be made of a linear electric motor.

In an embodiment, of which an example is shown in FIGS. 1-4, the processing station 10 may be provided with a single impression roller 12 which is placed in a bearing assembly 38 which is displaceable so that the impression roller 12 is displaceable between a first position P1 (shown in FIGS. 1-4) and a second position P2. The impression roller 12 in the first position P1 is, with insertion of the substrate web S, in engagement with the first tool cylinder 14, and the substrate web S is not in engagement with the second tool cylinder 16. In the second position P2 the impression roller 12 is, with insertion of the substrate web S, in engagement with the second tool cylinder 16, and the substrate web S is not in engagement with the first tool cylinder 14.

In the example of FIGS. 1-4, the two frame plates 66, 68 are provided with a slot 74 via which the impression roller 12 can be displaced from the first position P1 to the second position P2. In the example shown, no mechanism is shown with which this displacing can be carried out. It will be clear that this could be done manually, but that, in view of the time required therefor, this is not the most preferred possibility. Preferably, the bearing assemblies 38 of the impression roller are displaceable from the first position P1 to the second position P2 and back with a mechanism. Such a mechanism can be implemented in different ways, for example, use can be made of a ball circulating screw with the aid of which the bearing assemblies 38 of the impression roller 12 are displaceable. Other solutions are also among the possibilities, such as, for example, a pivoting mechanism whereby the bearing assemblies 38 of the impression roller 12 are connected with a pivoting arm and whereby fixation in the two positions P1 and P2 takes place with one or more locking pins.

The point is that in a relatively simple way the impression roller 12 can be brought from the first position P1 into the second position P2 and the other way around, and that the bearing assemblies 38 of the impression roller 12 in those positions P1 and P2 can be stably fixed with respect to the frame plates 66, 68.

In another embodiment, of which an example is shown in FIGS. 5-7, the processing station 10 may be provided with a first and a second impression roller 12, 22, which are each bringable into a respective impression roller 12, 22-associated operative position P12w and P22w, respectively, and a non-operative position P12n and P22n, respectively. The first impression roller 12 in the operative position P12w is, with insertion of the substrate web S, in engagement with the first tool cylinder 14. In the non-operative position P12n of the first impression roller 12, both the substrate web S and the impression roller 12 are not in engagement with the first tool cylinder 14. The second impression roller 22 in the operative position P22w is, with insertion of the substrate web S, in engagement with the second tool cylinder 16. In the non-operative position P22n of the second impression roller 22, both the substrate web S and the impression roller 22 are not in engagement with the second tool cylinder 16.

In the example of this embodiment that is shown in FIGS. 5-7, the two impression rollers 12, 22 are each adjustable via vertical slots 76, 78 in vertical direction relative to the frame plates 66, 68 and hence relative to the tool cylinders 14, 16. For this too, it holds that this adjustment can be carried out manually or in an automated manner. Obviously, here too, it holds that the automated variant is preferred. Automation, just as with the first embodiment as discussed above, may be implemented in different ways. For example, the bearing assemblies 38 of the impression rollers 12, 22 may be displaceably connected with the frame plates 66, 68 and be adjustable relative to the frame plates 66, 68, for example by means of ball circulating screws, pivoting arms or linear motors.

In an embodiment, of which two examples are shown in FIGS. 1-7, at least the first and the second tool cylinder 14, 16 and the impression roller 12; 12, 22 are included in a housing 40 which is provided with two separate access openings 42, 44 which are each closable with an associated door 46, 48. The two doors 46, 48 are openable and closable independently of each other. A first of the two access openings 42 provides access to the first tool cylinder 14 and not to the second tool cylinder 16. A second of the two access openings 44 provides access to the second tool cylinder 16 and not to the first tool cylinder 14.

The housing 40 in the examples shown is formed by the two frame plates 66, 68, the two end walls 70, 72 and two doors 46, 48 hinged to the end walls. When the processing station 10 is operative, it is preferred that only one of the doors 46, 48 can be opened, namely the door which provides access to the tool cylinder 14, 16 that is not operative and so does not rotate either. A partition 80 prevents an operator accidentally coming into contact with the rotating tool cylinder 14, 16 which is behind the closed door 46, 48.

In an embodiment, of which two examples are shown in the figures, the first and the second tool cylinders 14, 16 may be of the magnetic type on which a metal tool plate 18 is securable with the aid of magnetic force.

Such magnetically energizable tool cylinders 14, 16 make a quick exchange of a tool plate 18 possible and moreover provide an operationally reliable attachment of a tool plate 18 on the tool cylinder 14, 16, even when the wrap length of the tool plate 18 is considerably smaller than the circumference of the tool cylinder 14, 16.

In an embodiment, at least one of the tool plates 18 can be a die plate.

In another embodiment, at least one of the tool plates 18 can be an embossing plate.

In yet another embodiment, at least one of the tool plates 18 can be a printing plate.

The processing station 10 can therefore carry out different activities. It will be clear that when the tool plate 18 is a printing plate, the processing station 10 will also need to have an inking assembly available. Such inking assemblies are known to the skilled person and may for instance be tailored to the type of printing plate. Thus, the processing station may be suitable for offset printing, flexographic printing, intaglio printing and like printing processes known per se.

In an embodiment, of which two examples are shown in the figures, the processing station 10 may be provided with a control 50 which is configured to control the periodic variation of the transport speed of the substrate web S at the contact area depending on a wrap length of the tool plate 18 and the diameter of the tool cylinders 14, 16.

In the exemplary embodiments shown, it will be possible to realize this by suitable control of the drive 52 and hence of the reciprocating pivoting movement of the pivoting arm 58. Both the amplitude of the stroke of the pivoting arm 58 and the frequency of the pivoting arm 58 may be varied depending on the wrap length of the tool plate 18 and the diameter of the tool cylinder 12 and if present 22. In other implementations of the mechanism for realizing the variable speed of the substrate web S, other solutions will be chosen, for example a suitable control of servo motors transporting the substrate web S.

In an embodiment, the control 50 can control the transport speed of the substrate web S at the contact area such that the distance between parts of the substrate web that have been processed by the tool cylinder 14, 16 is a small distance.

In further elaboration of one of these last two embodiments, when the apparatus comprises two sets of three idler rollers 24-28 and 30-34, as described above, the control 50 may be configured to control a drive 52 of the reciprocating movement of the roller frame 36 such that the speed of the substrate web S is in agreement with the circumferential speed of the tool cylinder 14, 16 when the tool plate 18 is in engagement with the substrate web S. The control 50 of the drive 52 is then moreover configured to vary the speed of the substrate web S when the tool plate 18 is not in engagement with the substrate web S, such that when the tool plate 18, as a result of the further rotating of the tool cylinder 14, 16 for a next processing operation, enters into engagement with the substrate web S again, this substrate web S, relative to the contact range, has not, or only over a small distance, been transported further.

This small distance which has been mentioned in the two above-discussed exemplary embodiments should be understood to mean a distance which is in the range of 0 to 10 cm.

Thus, hardly any substrate web material is lost, even when the tool plate 18 has a smaller wrap length than the circumference of the tool cylinder.

In an embodiment, of which two examples are shown in the figures, the impression roller 12 or the impression rollers 12, 22 may be rotatably drivable by an impression roller drive 82, 84 which is controllable for, within one revolution of the tool cylinder 14, 16, periodically varying the rotation speed of the impression roller 12; 12, 22 relative to the rotation speed of the tool cylinder 14, 16. The variation of the rotation speed of the impression roller 12; 12, 22 is in agreement with the periodically varying transport speed of the substrate web S at the contact area.

Such an embodiment hinders slip arising between the substrate web S and the impression roller 12, and, if present, 22. In this way, an operationally more reliable transport of the substrate web S as well as a better printing result is obtained.

The invention is not limited to the embodiments described and the examples shown. The protection is defined by the appended claims in which the reference numerals only serve for clarification and have no limiting effect.

English translation of a few terms:

| | |
|---|---|
| substraatbaan S | substrate web |
| gereedschapswals 14, 16 | tool cylinder |
| gereedschapsplaat 18 | tool plate |
| vrij roteerbare keerrollen | idler rollers |
| heen- en weer beweegbaar | mounted in a reciprocating movably |
| is opgesteld | manner |
| stansplaat | die plate |
| embossingplaat | embossing plates |
| drukplaat | printing plate |
| maatregelen | features (see claim 12) |

1. A processing station for processing a substrate web supplied and led away with a substantially continuous speed, comprising:
an impression roller;
a rotatably mounted tool cylinder on which a first tool plate is securable and which, in use, at a contact area, with insertion of the substrate web, engages the impression roller for carrying out a processing operation on the substrate web; and
a mechanism configured, within one revolution of the tool cylinder, to periodically vary a transport speed of the substrate web at the contact area relative to the rotation speed of the tool cylinder,
wherein the rotatably mounted tool cylinder includes a first and a second rotatably mounted tool cylinder which can each be provided with a tool plate,
wherein of the first and second tool cylinders, at any time only one is in an operative state while the other is in a non operative state,
wherein the operative state is provided in that an impression roller, with insertion of the substrate web, at a contact area is in engagement with the tool cylinder in the operative state,
wherein the non-operative state is provided in that the non-operative tool cylinder is not in engagement with the substrate web and an impression roller, and
wherein the non-operative tool cylinder of the first and second tool cylinders is available and accessible for thereon exchanging a tool plate.

2. The processing station according to claim 1, wherein the processing station, for the purpose of the variation of the transport speed of the substrate web at said contact area, comprises:
a first and a second set of three idler rollers, wherein over each set of three idler rollers, in use, the substrate web is guided zigzag, wherein each set of three idler rollers, viewed in the transport direction of the substrate web, comprises an upstream, an intermediate, and a downstream roller, wherein the upstream roller and the downstream roller have a rotation axis with a fixed position, and wherein the intermediate roller of both the first and the second set of three idler rollers is connected with a roller frame which is mounted movably in a reciprocating manner.

3. The processing station according to claim 1, wherein the processing station comprises a single impression roller which is placed in a bearing assembly which is displaceable so that the impression roller is displaceable between a first position and a second position, wherein the impression roller in the first position, with insertion of the substrate web, is in engagement with the first tool cylinder and the substrate web is not in engagement with the second tool cylinder, wherein the impression roller in the second position, with insertion of the substrate web, is in engagement with the second tool cylinder and the substrate web is not in engagement with the first tool cylinder.

4. The processing station according to claim 1, wherein the processing station comprises a first and a second impression roller, which are each bringable in a respective impression roller associated operative position and a non-operative position, wherein the first impression roller in the operative position, with insertion of the substrate web, is in engagement with the first tool cylinder, wherein in the non-operative position of the first impression roller both the substrate web and the impression roller are not in engagement with the first tool cylinder, wherein the second impression roller in the operative position, with insertion of the substrate web, is in engagement with the second tool cylinder, wherein in the non-operative position of the second impression roller both the substrate web and the impression roller are not in engagement with the second tool cylinder.

5. The processing station according to claim 1, wherein at least the first and the second tool cylinder and the impression roller; are included in a housing which is provided with two separate access openings which are each closable with an associated door, wherein the two doors are openable and closable independently of each other, wherein a first of the two access openings provides access to the first tool cylinder and not to the second tool cylinder and wherein a second of the two access openings provides access to the second tool cylinder and not to the first tool cylinder.

6. The processing station according to claim 1, wherein the first and the second tool cylinders are of the magnetic type on which a metal tool plate is securable with the aid of magnetic force.

7. The processing station according to claim 1, wherein at least one of the tool plates is a die plate.

8. The processing station according to claim 1, wherein at least one of the tool plates is an embossing plate.

9. The processing station according to claim 1, wherein at least one of the tool plates is a printing plate.

10. The processing station according to claim 1, wherein the processing station comprises a control which is configured to control the periodic variation of the transport speed of the substrate web at the contact area depending on a wrap length of the tool plate and the diameter of the tool cylinders.

11. The processing station according to claim 10, wherein the control controls the transport speed of the substrate web at the contact area such that the distance between parts of the substrate web that have been processed by the tool cylinder is a small distance.

12. The processing station according to claim 10, wherein the processing station, for the purpose of the variation of the transport speed of the substrate web at said contact area, comprises:
a first and a second set of three idler rollers, wherein over each set of three idler rollers, in use, the substrate web is guided zigzag, wherein each set of three idler rollers, viewed in the transport direction of the substrate web, comprises an upstream, an intermediate, and a downstream roller, wherein the upstream roller and the downstream roller have a rotation axis with a fixed position, and wherein the intermediate roller of both the first and the second set of three idler rollers is connected with a roller frame which is mounted movably in a reciprocating manner, and
wherein the control is configured to control a drive of the reciprocating movement of the roller frame such that the speed of the substrate web is in agreement with the circumferential speed of the tool cylinder when the tool plate is in engagement with the substrate web and that the speed of the substrate web is varied such, when the tool plate is not in engagement with the substrate web, that, when the tool plate as a result of the further rotating of the tool cylinder for a next processing operation enters into engagement with the substrate web again, this substrate web, relative to the contact range, has not, or only over a small distance, been transported further.

13. The processing station according to claim 11, wherein the small distance is in the range of 0 to 10 cm.

14. The processing station according to claim 1, wherein the at least one impression roller is rotatably drivable by an impression roller drive which is controllable for, within one revolution of the tool cylinder, periodically varying the rotation speed of the impression roller relative to the rotation speed of the tool cylinder, wherein the variation of the rotation speed of the impression roller is in agreement with the periodically varying transport speed of the substrate web at the contact area.

15. The processing station according to claim 2, wherein the processing station comprises a single impression roller which is placed in a bearing assembly which is displaceable so that the impression roller is displaceable between a first position and a second position, wherein the impression roller in the first position, with insertion of the substrate web, is in engagement with the first tool cylinder and the substrate web is not in engagement with the second tool cylinder, wherein the impression roller in the second position, with insertion of the substrate web, is in engagement with the second tool cylinder and the substrate web is not in engagement with the first tool cylinder.

16. The processing station according to claim 2, wherein the processing station comprises a first and a second impression roller, which are each bringable in a respective impression roller associated operative position and a non-operative position, wherein the first impression roller in the operative position, with insertion of the substrate web, is in engagement with the first tool cylinder, wherein in the non-operative position of the first impression roller both the substrate web and the impression roller are not in engagement with the first tool cylinder, wherein the second impression roller in the operative position, with insertion of the substrate web, is in engagement with the second tool cylinder, wherein in the non-operative position of the second impression roller both the substrate web and the impression roller are not in engagement with the second tool cylinder.

17. The processing station according to claim 2, wherein at least the first and the second tool cylinder and the impression roller are included in a housing which is provided with two separate access openings which are each closable with an associated door, wherein the two doors are openable and closable independently of each other, wherein a first of the two access openings provides access to the first tool cylinder and not to the second tool cylinder and wherein a second of the two access openings provides access to the second tool cylinder and not to the first tool cylinder.

18. The processing station according to claim 3, wherein at least the first and the second tool cylinder and the impression roller are included in a housing which is provided with two separate access openings which are each closable with an associated door, wherein the two doors are openable and closable independently of each other, wherein a first of the two access openings provides access to the first tool cylinder and not to the second tool cylinder and wherein a second of the two access openings provides access to the second tool cylinder and not to the first tool cylinder.

19. The processing station according to claim 4, wherein at least the first and the second tool cylinder and the impression roller are included in a housing which is provided with two separate access openings which are each closable with an associated door, wherein the two doors are openable and closable independently of each other, wherein a first of the two access openings provides access to the first tool cylinder and not to the second tool cylinder and wherein a second of the two access openings provides access to the second tool cylinder and not to the first tool cylinder.

20. The processing station according to claim 2, wherein the first and the second tool cylinders are of the magnetic type on which a metal tool plate is securable with the aid of magnetic force.
